(19) United States
(12) Patent Application Publication
(10) Pub. No.: US 2025/0162701 A1
(43) Pub. Date: May 22, 2025

(54) AUTONOMOUS CAPTIVE AEROSTAT WITH DEVICES FOR GENERATING AND CONVERTING SUSTAINABLE CARBON-FREE ENERGY

(71) Applicant: Guilhem GREGORI, Paris (FR)

(72) Inventor: Guilhem GREGORI, Paris (FR)

(21) Appl. No.: 18/556,698

(22) PCT Filed: Apr. 22, 2022
(86) PCT No.: PCT/FR2022/000037

§ 371 Date: Jul. 9, 2024

(30) Foreign Application Priority Data
Apr. 23, 2021 (FR) FR2104252

(51) Int. Cl. B64B 1/50

(52) U.S. Cl. CPC B64B 1/50

(57) ABSTRACT

The present invention relates to an autonomous captive aerostat (2) of the type comprising a closed hydrogen-reservoir volume (24) providing lift, an outer membrane (40) equipped with photovoltaic cells (8) for collecting solar radiation, and a ground tether (20) comprising a cable for transmitting the electrical energy produced by the cells (8). The captive aerostat according to the invention is notable in that it comprises devices (4) for capturing water or moisture contained in the atmosphere constituting its outer membrane (40), means enabling this water to be converted into at least one form of energy selected from hydrogen, oxygen and heat, and pipes each enabling some of the collected water and at least one of the forms of energy generated or converted within the aerostat to be distributed to the ground. Applicable notably to the distribution of energy to urban environments.

The present invention relates to an autonomous captive aerostat with devices for generating, converting and transporting sustainable, carbon-free energies.

### PRIOR ART

Faced with the problems of pollutant emissions on the one hand, and the cost of extraction and the increasing scarcity of fossil fuels on the other, new sources of renewable energies are currently being sought.

The Earth receives solar radiation that forms a uniformly distributed energy, with an intensity that decreases as it descends into the atmosphere, this descent causing both a reflection of part of this energy and an attenuation by passing through the clouds, gases or dust contained in this atmosphere.

It is also known that a rise in altitude leads to a further distance from the horizon, which increases the daily sunshine duration.

In order to recover solar energy at altitude, a known type of captive aerostat, presented in particular in document US-A1-2015/0053255, comprises a horizontally elongated balloon, having a parabolic reflector underneath which makes it possible to reflect and concentrate solar radiation towards photovoltaic cells fixed underneath this balloon, in order to optimise energy recovery.

The energy is then transmitted by an electrical ground tether cable.

Another known type of captive aerostat, presented in particular in document WO Al-2016/141484 or in document WO-A-2013/173196, comprises a series of solar panels facing the sky, connected together to form an artificial cloud, which receive solar radiation directly in order to transform it into electrical energy which is then transmitted to the ground via a tether cable.

These various known systems require closed volumes to be filled at ground level with a lighter-than-air gas, either hydrogen or helium, in order to ensure that the station is maintained at height. However, as these light gases have very small molecules, there is a constant loss through the envelopes containing them.

Thus, if we know from document CN-1.222.785 A an autonomous captive aerostat comprising an outer membrane equipped with photovoltaic cells for receiving solar radiation completed with a ground tether comprising a cable for transmitting the electrical energy produced by the cells, said aerostat also comprising a closed hydrogen-reservoir volume providing lift, it should be noted in this respect that it is through the tether between the Earth and the aerostat, and from the Earth, that the hydrogen necessary for the lift of said aerostat is distributed. To ensure this, large volumes of hydrogen need to be stored on the ground, and these stocks need to be replenished from time to time.

Consequently, an attempt can be made to optimise the altitude of the aerostat by varying the volume of the lift gas, in order to achieve continuous adaptation of the best energy production compromise to suit the needs.

It may then also be necessary to provide a regular gas top-up, such as, for example, a supply via a pipe included in the ground tether as proposed in document CN-1.222.785 A, or by periodic descent of the aerostat to the ground in order to top up its gas volume.

These operations require ground supply or filling installations which take up space, involve handling, reduce the availability of the aerostat in the atmosphere to produce energy, and lead to complications and costs to the detriment of the profitability of the installation.

Furthermore, if it is desired to store energy in the aerostat, for example to conserve energy received during the day in order to distribute it regularly during the night, the use of batteries to store a quantity of electrical energy poses significant mass problems which must be compensated for by very high volumes of lift gas.

### PRESENTATION OF THE INVENTION

The purpose of the present invention is, in particular, to avoid these problems of the prior art.

To this end, said invention relates to an autonomous captive aerostat comprising a closed hydrogen-reservoir volume providing lift, an outer membrane equipped with photovoltaic cells for collecting solar radiation, and a ground tether comprising a cable for transmitting the electrical energy produced by the cells, said captive aerostat being notable in that it comprises devices for capturing water or moisture contained in the atmosphere constituting its outer membrane, means enabling this water to be converted into at least one form of energy selected from hydrogen, oxygen and heat, and pipes each enabling some of the captured water and at least one other of the forms of energy generated or converted within the aerostat to be distributed to the ground.

Quite advantageously, the captive aerostat then comprises an electrolyser for the captured water capable of releasing hydrogen gas used to supply the hydrogen-reservoir volume and also to supply a pipe for distributing this hydrogen gas to the ground.

One advantage of this aerostat is that, by means of the devices for capturing water or water steam contained in the atmosphere, water is obtained which can be autonomously decomposed into oxygen and hydrogen in the electrolyser, using the electrical energy produced by the photovoltaic cells.

The hydrogen thus converted can then be used to additionally supply the closed reservoir volume, which can be frequent and without interrupting energy production, in order to optimise in particular the flight height of the aerostat to ensure the best energy efficiency.

Moreover, means of storing the energy from the electricity in gaseous form is simply obtained, having a very low mass, which can be stored in the aerostat or delivered to the ground via one of the ground distribution pipes.

The captive aerostat according to the invention may additionally comprise one or more of the following features, which may be combined together.

Thus, the captive aerostat may also comprise a closed volume for storing oxygen gas.

In such a case, the ground tether will include a pipe for distributing the oxygen gas to the ground.

Advantageously, the ground tether may also comprise a pipe for bringing down air taken from the atmosphere.

Advantageously, the devices for capturing water or moisture contained in the atmosphere which constitute the outer membrane comprise a polymer matrix which can become hydrophilic or hydrophobic by a change of state, with a reorganisation of its molecules depending on the external environment.

In addition, the polymer matrix can be thermosensitive, containing a hydrogel which, when stimulated, becomes hydrophobic, causing the water captured in the matrix to be released in liquid form.

Also advantageously, the outer membrane can comprise flexible organic photovoltaic films enabling it to follow the deformations of the balloon.

Still advantageously, the outer membrane or the ground tether can comprise cords with piezoelectric properties, which stretch or contract according to the deformations of the balloon or according to the elongation of said ground tether, thereby producing electricity.

The captive aerostat according to the invention will preferably comprise an automated control system implementing an optimisation algorithm which will make choices to suit the demand in energies, thereby implementing a conversion matrix for production and transformation of the energies.

In this case, advantageously, the optimisation algorithm comprises devices adapted for receiving data from weather stations.

The optimisation algorithm may also comprise devices adapted for receiving elements measured by the balloon's probes and sensors, including the altitude, wind speed, temperature, sunshine, hygrometry, composition of the air with a measurement of fine particles, organic compounds, carbon dioxide and nitrogen, and the state of its reserves in energies and fluids.

Finally, the optimisation algorithm may also comprise devices adapted for receiving elements comprising information about the demands from buildings on the ground, elements anticipated by analysing past energy needs relating to user consumption, and elements deduced therefrom, comprising the means required to satisfy future demand, by transforming energy or by using available energy stocks.

### BRIEF DESCRIPTION OF THE DRAWINGS

The invention will be better understood and other characteristics and advantages will become clearer on reading the description given below by way of example, with reference to the annexed drawings in which:

FIG. 1 is a general graph of flows circulation for an aerostat according to the invention; and

FIG. 2 is a vertical section diagram of this aerostat

### DESCRIPTION OF PREFERRED EMBODIMENTS

Throughout the document, the top and bottom sides and the expressions above or below are relative to a vertical axis with respect to the Earth.

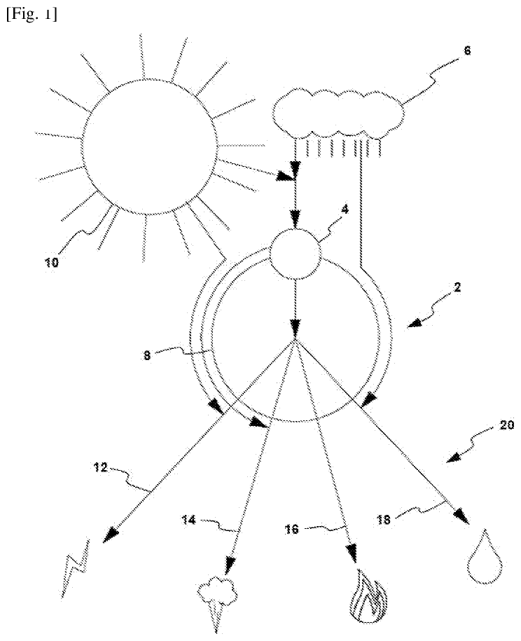

FIG. 1 shows an aerostat according to the invention forming a captive balloon 2 maintained at altitude, comprising a closed hydrogen-reservoir volume providing lift, surface membranes with devices for capturing water 4 in the form of water steam contained in the air or droplets originating from fog or clouds 6, and photovoltaic cells 8 producing electric current from solar radiation 10.

The balloon 2 comprises various devices for transforming and storing energies, making it possible to ensure flows along the tether 20 with the ground in order then to distribute these energies to users on the ground, in particular an electric current 12 and a flow of hydrogen 16. In addition, the balloon 2 can distribute complementary flows to users, such as a flow of drinking water 18, fresh air 14 or oxygen gas.

Hydrogen, which constitutes a source of energy by combustion or oxidation with oxygen in the air, in particular in a fuel cell to produce electricity, is currently obtained for more than 95% from non-renewable fossil resources and emit pollutant gases, this process therefore not being very environmentally friendly.

Hydrogen can also be obtained from renewable energy, also called green hydrogen, in particular by electrolysis of water.

Hydrogen is being developed to power vehicles. It can also be used to heat residential or professional buildings, but storage poses major problems because of the high pressure required to limit the volume of the reservoirs, of the relative permeability of the reservoir shells, and the fact that it is highly flammable, requiring major precautions to avoid accidents.

Since it is difficult to transport and store hydrogen, it may be advantageous to have small continuous hydrogen productions distributed over an area, making it possible to supply consumers located near these sources continuously and in proportion to their needs, in order to limit the storage and transport of this gas.

In particular, as the aerostat according to the invention delivers electrical energy, a flow of hydrogen, a flow of oxygen and water to the ground at the same time, and in proportions resulting from an energy optimisation of their production and a balance of the needs on the ground, it ensures a high degree of flexibility enabling the best efficiency to be obtained under all conditions.

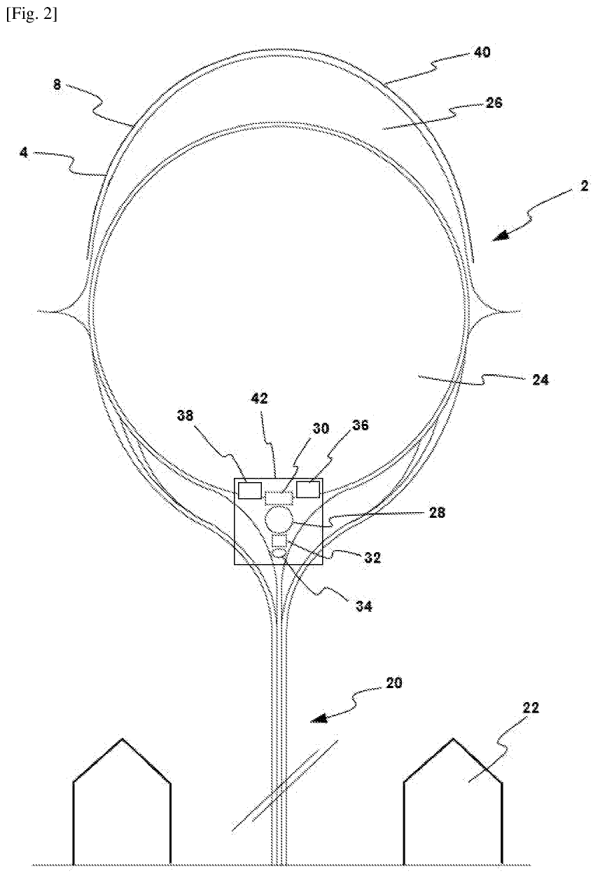

Particularly with an aerostat in altitude, placed above the clouds if necessary, the electricity and hydrogen available every day can be used immediately, for example to heat buildings close to the ground tether, or to fill batteries or hydrogen tanks in vehicles.

[FIG. 2] shows the balloon 2 connected to the ground by a ground tether, a tether marked by 20 in its entirety, which is flexible, comprising an assembly of flexible connections including a wire for anchoring to the ground and for winding, thus making it possible to regulate the altitude of the aerostat, a cable for transmitting electrical energy, flexible polymer pipes for conducting hydrogen gas H₂, for conducting oxygen gas O₂, for conducting liquid water H₂O, for the passage of fresh air, and if necessary signal transmission cables using electrical conductors or optical fibres.

The ground tether 20 may contain extensible cords with piezoelectric properties which also generate electricity which is recovered by elongation of this deformable connection.

The various cables or conduits of the ground tether 20 start from a gondola 42 located under the balloon, grouping together all the technical operating elements of the aerostat. The gondola 42 under the balloon makes it possible, when the aerostat is lowered back to the ground, to easy access to technical components for inspection and maintenance.

The balloon 2 is kept close to buildings 22 to receive instructions for controlling this balloon with its various energy transformations, and to supply these buildings with energy. Ideally, it is the roofs of said buildings that will be connected to the various pipes carrying the desired energies from the balloon 2, which energies will then be distributed from the roofs to the centres supplying the buildings with the desired energy.

The substantially spherical balloon 2 comprises a closed main hydrogen-reservoir volume 24 occupying a major part of the sphere, having a membrane which is sufficiently impermeable to this gas, which ensures the balloon's lift, and a closed auxiliary oxygen storage volume 26 arranged above the upper half of the main hydrogen-reservoir volume 24.

The entire balloon 2 is covered by an outer membrane 40 comprising both photovoltaic films 8 for producing electric current and a surface acting like a sponge, a surface which is therefore hydrophilic in order to absorb the ambient humidity present in the form of steam or droplets, in order to release liquid water which is then stored in a water tank 28 arranged in the gondola 42.

Advantageously, an outer polymer membrane 40 is used, which can also become hydrophobic by a change of state, with a reorganisation of its molecules according to the external environment. In particular, the membrane may be a heat-sensitive polymer matrix containing a hydrogel which, when stimulated by solar radiation, becomes hydrophobic by causing the water captured in this matrix to return to liquid form. This supplies the water tank 28 or the water distribution pipe to the ground, as required.

The production of electricity by solar energy is preferably also ensured by flexible organic photovoltaic films 8, applied in a serpentine on the outer membrane of the balloon 2, which today constitute a third generation of photovoltaic cells formed with semi-transparent and ultra-thin films.

Semiconductor materials are printed and superimposed in a thin layer on the outer membrane 40, which remains flexible in order to follow the deformations of the balloon 2, and has a very large surface area that is well exposed to solar radiation.

In addition, the semiconductor materials of the photovoltaic cells 8 can, by heating, act directly on the temperature of the outer membrane 40, to directly control the change of state of this membrane in order to ensure its hydrophilic aspect of water capture, or its hydrophobic aspect of restitution of this water.

The outer membrane 40 is made of flexible polymers, resistant to ultraviolet radiation and fire, advantageously comprising cords with piezoelectric properties in order to also obtain electricity production by the deformation of this membrane, thus supplementing that coming from the photovoltaic cells 8.

In particular, the piezoelectric cords forming an integral part of the outer polymer membrane 40 may be cords that expand and contract reversibly according to a coefficient of elongation ranging from 200 to 750%. A wire attached to a winder can manage the variation in elongation in order to produce electrical energy.

The gondola 42 also advantageously comprises an electrolyser 30 which is supplied by the water tank 28, with a supply of an acidic or basic water-soluble solution 38 making it possible to conduct the current between two electrodes receiving the electric current produced by the photovoltaic films 8, this in order to decompose the liquid water into gaseous dioxygen and dihydrogen. These two gases are then stored in their respective reservoir volumes 24, 26 described above.

A pump 36 is used to regulate water circulation if necessary.

Using the electric current it receives from the photovoltaic films, the electrolyser 30 simply applies the principle: 2H₂O+electricity→O₂+2H₂.

Alternatively, the electrolyser 30 may be of the polymer electrolyte membrane type, also known as “MEP”, allowing proton exchanges between two compartments each accommodating an electrode, while being impermeable to the passage of gases.

The electrolysis of water makes it possible to use surplus electricity produced by the photovoltaic films 8, in order to transform this energy into hydrogen which can be stored on site in the hydrogen-reservoir volume 24, in particular as a function of the lift requirements of the balloon 2.

Electric or hydrogen energies are sent to the ground according to demand and satisfy it. Surplus electricity is converted into hydrogen gas, which is stored in the hydrogen reserve.

Hydrogen gas is transmitted to the ground via the pipe for this gas integrated into the ground tether 20, in particular to supply the buildings 22 and to heat them. Similarly, a surplus of oxygen gas can be sent to the ground via the pipe for this gas integrated into the ground tether 20.

Similarly to the water recovered at altitude, which is purified by distillation at the level of the membrane, a surplus of production unused by the electrolyser 30 is sent to the ground via the water distribution pipe, in order to be used in particular for drinking water in the buildings 22. Pure air can also be taken from altitude, which is sent to the ground via a pipe integrated into the ground tether 20, for example in order to renew the indoor air in the buildings 22 using their controlled mechanical ventilation systems.

The aerostat comprises an automated control system 32, in particular an on-board computer comprising a control panel which implements an optimisation algorithm receiving numerous items of information from different sources, with the aim of being able to determine the actions to be carried out.

Thus, in particular, this optimisation algorithm will receive the elements measured by the various probes and sensors 34 in the balloon 2, including in particular altitude, wind speed, temperature, sunshine, hygrometry and air composition with, in particular, a measurement of fine particles, organic compounds, carbon dioxide and nitrogen. Of course, the algorithm is also constantly aware of the state of its reserves in energies and fluids.

This optimisation algorithm, thus ensuring the link between demand and supply, also receives a set of elements comprising information about the demands of buildings on the ground 22, and elements anticipated by the analysis of past energy needs relating to user consumption. It also receives deduced elements, including the means required to satisfy demand, in particular by transforming energy, or simply using available energy stocks.

The algorithm is of course also connected to nearby weather stations, in order to anticipate future levels of precipitation and sunshine.

This algorithm thus executes a conversion matrix, a means of regulating supply and demand in order to manage the production and transformation of energies (electricity, hydrogen gas, oxygen gas, water and heat) and continuously calculate the altitude of the aerostat. It continuously cross-references and compiles data in order to initiate strategic choices and orientations.

As the aerostat according to the invention requires only a very small surface area on the ground, it is particularly suitable for dense urban environments and large, more polluted cities. It may also be suitable for old buildings with a high architectural, historical or financial value, but which paradoxically have a poor energy balance with high energy losses and difficulties in adapting to modern energy conservation technologies.

The aerostat is particularly suitable for industrial mass production, thus making it possible to reduce manufacturing costs, particularly those of its highly technical components such as the outer membrane.

1. An autonomous captive aerostat comprising a closed hydrogen-reservoir volume providing lift, an outer membrane equipped with photovoltaic cells adapted to receive solar radiation, and a ground tether comprising a cable adapted to transmit electrical energy produced by the cells devices for capturing water or moisture contained in the atmosphere constituting an outer membrane of the aerostat, means enabling this water to be converted into at least one form of energy selected from hydrogen, oxygen and heat, and pipes each enabling some of the captured water and at least one other of the forms of energy generated or converted within the aerostat to be distributed to the ground.

2. A captive aerostat according to claim 1, further comprising an electrolyser for the captured water capable of releasing hydrogen gas used to supply the hydrogen-reservoir volume as well as a pipe for distributing this hydrogen gas to the ground.

3. A captive aerostat according to claim 1, further comprising a closed oxygen gas-reservoir volume.

4. A captive aerostat as claimed in claim 3, wherein the ground tether comprises a pipe for distributing oxygen gas to the ground.

5. A captive aerostat according to claim 1, wherein the ground tether comprises a pipe for bringing down air taken from the atmosphere.

6. A captive aerostat according to claim 1, wherein the devices for capturing water or moisture contained in the atmosphere comprise a polymer matrix which can become hydrophilic or hydrophobic by a change of state, with a reorganization of its molecules depending on an external environment.

7. A captive aerostat according to claim 6, wherein the polymer matrix is thermosensitive, containing a hydrogel which, when stimulated, becomes hydrophobic, causing the water captured in this matrix to be released in liquid form.

8. A captive aerostat according to claim 5, wherein the outer membrane comprises flexible organic photovoltaic films making it possible to follow deformations of the aerostat.

9. A captive aerostat according to claim 5, wherein the outer membrane or the ground tether comprises cords with piezoelectric properties, which stretch or contract according to deformations of the aerostat or according to an elongation of said ground tether, thereby producing electricity.

10. A captive aerostat according to claim 1, further comprising an automated control system implementing an optimisation algorithm adapted to make choices to suit a demand in energies, implementing a conversion matrix for production and transformation of the energies.

11. A captive aerostat as claimed in claim 10, wherein the optimisation algorithm receives information from devices adapted for receiving data from weather stations.

12. A captive balloon according to claim 10, wherein the optimisation algorithm receives information from devices adapted for receiving elements measured by probes and sensors of the aerostat, comprising altitude, wind speed, temperature, sunshine, hygrometry, composition of the air with a measurement of fine particles, organic compounds, carbon dioxide and nitrogen, and the state of its reserves in energies and fluids.

13. A captive aerostat according to claim 10, wherein the optimisation algorithm receives information from devices adapted for receiving elements comprising information about the demands from buildings on the ground, elements anticipated by analysing past energy needs relating to user consumption, and deduced elements comprising e means necessary to satisfy future demand, by transforming energy or by using available energy stocks.
